(19) United States
(12) Patent Application Publication
(10) Pub. No.: US 2024/0322414 A1
(43) Pub. Date: Sep. 26, 2024

(54) WAVEGUIDE SEGMENT AND METHOD FOR PRODUCING AT LEAST ONE WAVEGUIDE SEGMENT FOR MICROWAVE ANTENNAS

(71) Applicant: Robert Bosch GmbH, Stuttgart (DE)

(72) Inventors: Alexander Fischer, Untergruppenbach (DE); Andreas Kugler, Alfdorf (DE); Armin Himmelstoss, Weissach Im Tal (DE)

(21) Appl. No.: 18/443,017

(22) Filed: Feb. 15, 2024

(30) Foreign Application Priority Data
Mar. 23, 2023 (DE) 10 2023 202 640.6

(51) Int. Cl. H01P 3/12; H01P 11/00

(52) U.S. Cl. CPC H01P 3/121; H01P 11/002

(57) ABSTRACT

A waveguide segment for microwave antennas. The waveguide segment is embodied as an injection-molded part that is metallized with a solderable metal surface.

### CROSS REFERENCE

The present application claims the benefit under 35 U.S.C. § 119 of German Patent Application No. DE 10 2023 202 640.6 filed on Mar. 23, 2023, which is expressly incorporated herein by reference in its entirety.

### FIELD

The present invention relates to a waveguide segment and a method for producing at least one such waveguide segment for microwave antennas.

### BACKGROUND INFORMATION

Microwave antennas are used in radar systems for motor vehicles, for example. Such microwave antennas or waveguide antennas have very good high-frequency properties and can contribute to a smaller installation space for radar sensors.

German Patent No. DE 103 46 847 B4 describes a microwave antenna consisting of:
a dielectric carrier comprising at least one strip conductor,
a metallic or metallized cover disposed above the dielectric carrier on its strip conductor side, into which at least one, in particular, funnel-shaped or horn-shaped waveguide radiator is integrated, wherein the base or the exciter-side end of the funnel-shaped or horn-shaped waveguide radiator is disposed above one of the strip conductors,
a transformation element above the strip conductor for the transition from the strip conductor to the opening the waveguide radiator,
wherein the transformation element is disposed laterally next to the waveguide radiator.

In this microwave antenna, the waveguide radiator(s) are each housed separately in a cover or together in a cover, which is configured as a SMD component. The cover is metallic or consists of partially metallized plastic and is shaped in such a way that it can be applied to an HF substrate by means of adhesive bonding and/or plug-in mounting. Such partially metallized plastic antennas can be made in almost any shape to ensure a transition from the microstrip line to the antenna radiator. Combinations of materials with different dielectric constants are possible, too. Other radiator shapes besides horn antennas or funnel antennas can be integrated into the cover configured as the SMD component as well.

### SUMMARY

An object of the present invention is to provide a waveguide segment and a method for producing at least one such waveguide segment for microwave antennas that are used in radar sensors, which enables cost-effective production of radar sensors.

To produce radar sensors cost-effectively and be able to use the advantages of waveguide antennas, it is necessary to forgo high-frequency laminates when feeding the waveguides and nonetheless, with the waveguide, enable and implement a low-loss and cost-effective coupling of integrated components, in particular MMICs (monolithic microwave integrated circuits), which are common in high-frequency technology and microelectronics.

The waveguide segment according to an example embodiment of the present invention is embodied as an injection-molded part that is metallized with a solderable metal surface. The embodiment as an injection-molded part enables not only simple production, but also simple adaptation to desired waveguide geometries and thus a very advantageous realization of desired microwave antennas.

According to an example embodiment of the present invention, the at least one waveguide segment is preferably produced with an open channel for assembly on a metal structure on a printed circuit board, for example on a strip conductor.

The actual waveguide is then realized by fastening the waveguide segment to the printed circuit board.

The assembly is preferably carried out using SMD technology. The waveguide segment advantageously comprises connections for SMD assembly.

According to one aspect of the present invention, the at least one waveguide segment is configured in such a way that it can handled by an automated assembly system, in particular an SMD assembly system.

It is preferably configured in such a way that it is recognized, in particular optically recognized, in the automated assembly system, for example in an SMD assembly system, and can be precisely positioned in an automated assembly process.

The automated assembly process is in particular a SMD assembly process.

The method according to an example embodiment of the present invention for producing at least one waveguide segment for microwave antennas, which is characterized by the steps:
producing the at least one waveguide segment by means of injection molding;
metallizing the at least one waveguide segment with a solderable metal surface,

enables the cost-effective production of waveguide segments for microwave antennas and thus waveguide antennas that are used in radar sensors. This simple and more cost-effective production of individual waveguide segments by means of injection molding and their metallization is, as already mentioned above, an essential aspect of the present invention.

It is also possible to mold additional horn antennas onto these individual cost-effective waveguide segments, for instance, without the waveguide having to be produced in multiple spraying processes and then assembled.

One aspect of the present invention provides for producing the at least one waveguide segment using digital injection molding (DIM) technology. This enables a particularly precise production of the waveguide segments.

A particularly advantageous aspect of the present invention provides for producing a plurality of waveguide segments in one panel. Thus a plurality of waveguide segments are produced simultaneously in one injection molding work step.

These waveguide segments are particularly preferably packaged after being separated in packaging that is compatible with an automated assembly process. They can thus be fed directly into an assembly process.

A packaging that is compatible with the automated assembly process can be a tape and reel packaging, for example.

### BRIEF DESCRIPTION OF THE DRAWINGS

Embodiment examples of the present invention are shown in the figures and explained in more detail in the following description.

FIG. 1 shows an illustration of a waveguide segment on a printed circuit board, according to an example embodiment of the present invention.

FIG. 2 shows a flow chart for producing a microwave antenna, according to an example embodiment of the present invention.

### DETAILED DESCRIPTION OF EXAMPLE EMBODIMENTS

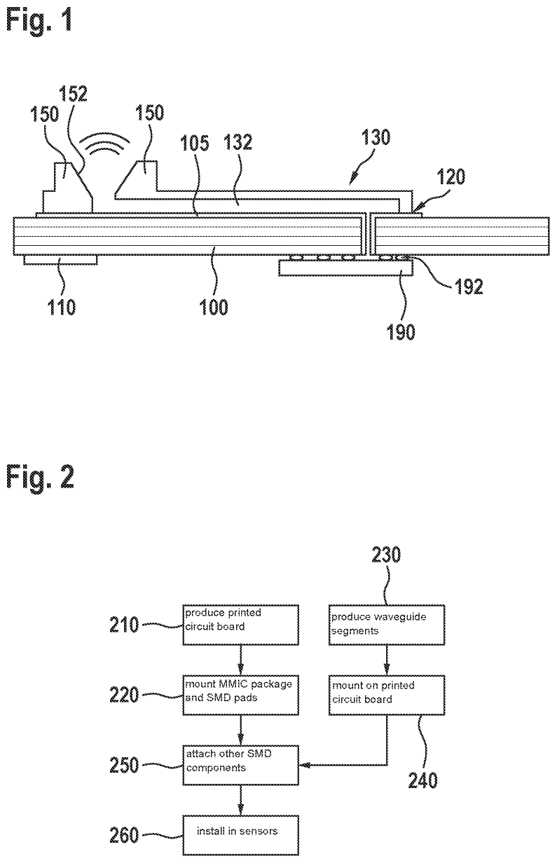

In a step 230 (see FIG. 2), a waveguide segment 150 (see FIG. 1) is first produced by means of injection molding, in particular using digital injection molding (DIM) technology. The waveguide segment 150 can in particular also be produced in a panel, in which a plurality of such waveguide segments 150 are produced in one injection molding work step, separated after production and packaged, for example in a tape and reel packaging, so that they can easily be fed into an automated assembly process which is explained in the following.

The waveguide segments 150 are constructed in such a way that they are open on their underside and a channel 132 can be produced by mounting them (240) on a printed circuit board 100. In this case, the lower wall of the waveguide segment 150 is formed by a printed circuit board 100, for example, onto which the waveguide segment 150 is mounted. On its upper side facing the waveguide segment 150, the printed circuit board 100 comprises a metal structure 105. The waveguide segment 150 itself is metallized and comprises a solderable metal surface. It is fastened in an electrically conductive manner to the metallic structure 105 of the printed circuit board 100 by means of a solder connection 120, for example. The waveguide segment 150 is configured in such a way that it can be handled by a (not depicted) automated assembly system, preferably an SMD assembly system. It has to in particular be configured in such a way that it is recognized, in particular optically recognized, in the automated assembly system for example in an SMD assembly system, and can be precisely positioned in an automatic assembly process.

The printed circuit board 100 is connected to a so-called MMIC package (monolithic microwave integrated circuit package) 190, for example via respective solder connections 192. The printed circuit board 100 further comprises SMD pads 110 on its underside for assembly using SMD technology. The metallization of the waveguide segments 150 is carried out in a conventional manner. Due to the small segments, a wide variety of technologies can be used here, because significantly less spray material is used and therefore more expensive material with metal seeds can also be used. Technologies such as PVD (physical vapor deposition), ALD (atomic layer deposition), chemical-reductive deposition, electroplating (galvanic), CVD (chemical vapor deposition) are used to produce the metallization of the waveguide segments 150. In every case, the metallization has to be configured such that it is solderable, so that the waveguide segments 150 can be fastened and contacted directly with assembly of the SMD components on the circuit board 100 by means of a soldering process. The waveguide segments 150 are mounted on the circuit board 100 using SMD technology. A variety of other SMD components are attached in this work step as well. This is shown in step 250.

In steps 210 and 220, the printed circuit board 100 is produced and the MMIC package and the SMD pads 110 are mounted. As mentioned, the waveguide segments 150 are configured in such a way that they can be directly recognized (for example optically), positioned and placed in a previously printed solder paste by a conventional SMD assembly machine and soldered directly to the SMD components in a reflow process. The waveguide segments 150 can alternatively also be mounted on the printed circuit board 100 using other conventional methods; for example using adhesive processes, plug-in processes or the like. In every case it has to be avoided that gaps form between the waveguide segment 150 and the metal structure 105 on the circuit board 100; or it has to be ensured that said gaps at least remain very small.

The thus produced assembly is then installed in sensors. The modular design makes it possible to produce a variety of sensors from the individual segments; only the assembly process has to be adapted or differently configured segments may possibly also have to be attached. But no additional tools and processes are needed. This is shown schematically in step 260 in FIG. 2.

What is claimed is:

1. A waveguide segment for a microwave antenna, wherein the waveguide segment is embodied as an injection-molded part that is metallized with a solderable metal surface.

2. The waveguide segment according to claim 1, wherein the waveguide segment includes an open channel for assembly on a metal structure on a printed circuit board.

3. The waveguide segment according to claim 1, wherein the waveguide segment comprises connections for SMD assembly.

4. The waveguide segment according to claim 1, wherein the waveguide segment is configured to be handled by an automated assembly system.

5. The waveguide segment according to claim 4, wherein the waveguide segment is configured to be handled by an SMD assembly system.

6. The waveguide segment according to claim 4, wherein the waveguide segment is configured in such a way that it is optically recognized in the automated assembly system to be precisely positioned in an automated assembly process.

7. The waveguide segment according to claim 6, wherein the automated assembly process is an SMD assembly process.

8. A method for producing at least one waveguide segment for a microwave antenna, the method comprising the following steps:
producing the at least one waveguide segment using injection molding;
metallizing the at least one waveguide segment with a solderable metal surface.

9. The method according to claim 8, wherein the at least one waveguide segment is produced using digital injection molding (DIM) technology.

10. The method according to claim 8, wherein a plurality of waveguide segments is produced in one panel.

11. The method according to claim 10, wherein the waveguide segments are packaged, after being separated, in packaging that is compatible with an automated assembly process.

12. The method according to claim 11, wherein the packaging that is compatible with the automated assembly process is a tape and reel packaging.
